(19) United States
(12) Patent Application Publication
(10) Pub. No.: US 2007/0074998 A1
(43) Pub. Date: Apr. 5, 2007

(54) Method and apparatus for screening kaolin

(76) Inventor: Herbert Gunther Joachim Langner, Brantford (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 11/242,120

(22) Filed: Oct. 4, 2005

(51) Int. Cl. B07B 1/18

(52) U.S. Cl. 209/284

(57) ABSTRACT

A rotary screening device is disclosed which includes a rotating cylinder formed from a number of coaxially aligned modular screening sections. Each cylindrical section having an inlet end, an outlet end and a cylindrical wall formed from a plurality of detachable screen panels each presenting a screening surface. The outlet end of a first cylinder section being secured in coaxial alignment with the inlet end of the next adjacent cylindrical section secured. The cylinder being rotatably supported on wheels within a containment housing which extends about the radial surfaces of the cylinder.

### SCOPE OF THE INVENTION

The present invention is directed to a rotary screening apparatus for separating solids from filtrate in an influent stream, and more particularly a rotary screening apparatus having a screening cylinder formed from one or more modular cylindrical drum sections comprised of a cylindrical frame and one or more replaceable screen panels.

### BACKGROUND OF THE INVENTION

Screening devices which incorporate rotating vibrating screens are well known for use in increasing the solid content of municipal sewage, sludge treatment, and food processing. Conventional rotating screening screens typically incorporate a hollow screening cylinder which is rotatably mounted within a containment housing in a generally upwardly inclined horizontal orientation on support wheels or a roller mechanism. The screening cylinder is journalled for rotation about its upwardly inclined axis. Influent to be screened is fed into the interior of the rotating cylinder at its lower end, and on to the screening surface. Filtrate from the influent then passes under gravity through openings in the screening surface, leaving behind solids which are too large to pass through the screens. The retained solids thereafter are moved upwardly along the interior of the cylinder and outwardly therefrom through an outlet end or opening.

In the classification or separation of fine clay particles from influent, such as the dewatering of Kaolin or kaolinite clays, heretofore, vibrating screen-type apparatus have been used. In vibrating screen apparatus, filtrate is pumped onto a horizontal or inclined screen panel which is oscillated of vibrated, to assist in the separation of solids and the passage of filtrate therethrough. Vibrating screening apparatus, however, are frequently less preferred as compared to rotary-type apparatus given the comparably high noise levels and require a number of replacement parts, as a result of the vibrational movement of the screen over its support.

Conventional screening devices suffer the disadvantage in that in their use, they are poorly suited to the efficient separation of very fine particles from filtrate, such as clays and the like. In particular, with conventional rotational screening devices, fine particles often clog or wedge in screen openings. In the case of rotational screening devices, clogging of the screening cylinder with fine solids often necessitates that the entire screening cylinder be removed from the containment housing and the cylinder screens replaced. To minimize the frequency of clogging and prolong screen life, heretofore conventional screening cylinders have used comparatively larger screen mesh sizes of less than 100 mesh, which have proven largely ineffective in the classification of kaolins and other clays.

A further difficulty with conventional screening apparatus exists as it is typically necessary to custom build each screening apparatus and screening cylinder to a selected axial cylinder length, depending on the specific type of influent and materials to be processed. In addition to limiting the adaptability of the apparatus for use on different product lines, with conventional rotary screening apparatus it is frequently necessary to custom build any replacement parts which may be required.

### SUMMARY OF THE INVENTION

An object of the invention is to provide a rotating screening apparatus having a screening cylinder made from one or more modular sections and which may be readily customized in length by the addition or removal of the modular sections, depending on the influent material to be processed.

Another object of the invention is to provide a rotary screening apparatus in which a casing is provided about the radial side surfaces of the screening cylinder to contain any spray from filtrate passing therethrough, and which permits simplified access to and replacement of individual screen panels without necessitating the removal of the screening cylinder from the containment housing.

A further object of the invention is to provide a casing for a rotating cylindrical screen having super fine mesh screen panels of size 300 mesh or finer, and more preferably at least about 400 mesh, and which have enhanced structural integrity for use in classifying kaolin and other clay solids from influent slurries.

Accordingly, to at least partially overcome some of the disadvantages of previously known devices, the present invention provides a rotating or rotary screening apparatus in which the screening cylinder is formed from one or more modular cylindrical sections which are secured in coaxial alignment. Preferably the screening surface of each cylindrical section is comprised of a number of replaceable screen panels which are attached to the exterior of a cylindrical frame. The panels may thus be removed for cleaning, repair or replacement from the exterior of the screening cylinder. Most preferably, each of the screen panels is in turn modular in nature, allowing interchangeability of panels and between different cylinder sections.

In the screening of kaolin and other clay solids from influent, a number of cylindrical sections may be coupled together, to provide the screening cylinder with a comparatively longer overall axial length of preferably more than about 2 meters and more preferably between about 4 and 6 meters. In addition screen panels having finer mesh openings sized at least 300 mesh and more preferably at least 400 mesh may also be provided. In the screening of fines, the screening cylinder is preferably also housed within a containment housing. In a preferred construction the containment housing includes a lower portion formed as an upwardly open trough. Although not essential, the trough has sides formed substantially from a single blank of metal and which functions both as the supporting frame for the cylinder and as a spray shield.

In another aspect the invention provides a rotary screening apparatus in which a containment housing is provided which substantially isolates the cylinder and which includes in an upper region thereof one or more sealable access doors which may be selectively opened to allow access to and replacement of clogged or worn screen panels from an exterior of the screening cylinder.

In another aspect, the screening cylinder of the present apparatus includes an influent input end, and an discharge end. The screening cylinder is formed by the mechanical attachment of the cylindrical sections to each other. Each cylindrical section includes a metal cylindrical support frame which includes a pair of spaced end hoops which are fixed in place by a series of axially extending frame members. In addition to providing the overall structural support to each section, the axial frame members and hoops also function as the mounting surface to which the screen panels are secured.

In a most preferred construction, the screen panels are formed as a three layer construction having a support plate, a replaceable screen membrane and a seal member. The seal member preferably is formed as a gasket and consists of an elastomeric material such as rubber, silicon or the like. The seal member is positioned to provide a substantially fluid-tight seal between the screen panel and the support frame. In the screening of clays such as kaolin, the screen membrane preferably consists of a 400 mesh stainless steel. Other screen materials and mesh sizes may however also be used depending on the influent to be classified. The outer support plate preferably consists of 0.2 to 1.5 cm thick aluminium, stainless steel or other metal plating, depending on the influent material and corrosion resistive property desired. Preferably the outer support plates have a longitudinal length selected at between about 0.5 and 2 meters. The support plates are curved across their lateral width with substantially the same radius of curvature as the hoop ends. The support plates have a preferred lateral width of between about 0.3 to 1 meters, depending on the overall size of the screening cylinder to be assembled.

When configured for use in the classification of kaolin and other fine clay solids, the screening cylinder is preferably rotatably supported on wheels or other such roller mechanism, with the influent input end spaced vertically above the filtrate discharge end. In use, the cylinder is journalled for rotation about its central longitudinal axis, while influent is pumped through the input opening and onto the interior screen membrane surface of the rotating screen panels.

More preferably the containment housing is formed as a substantially unitary external casing provided about part, and more preferably the entire circumferential surface of the screening cylinder for containing filtrate. In such a construction openings are formed through regions of the casing and which are covered by one or more sealable access doors. The openings and access doors are preferably provided towards the upper peripheral region of the screening cylinder. The casing openings and access doors have a size selected to permit access to the exterior surface of one or more modular cylindrical sections. More preferably the openings and access doors are sized so as to enable removal and replacement of the screen panels therethrough, without necessitating disassembly of the screening apparatus or removal of screen panels from the interior of the screening cylinder.

In an alternate possible construction the containment housing may include a top cover which may be bolted in place or alternately removably or hingely coupled to a lower integral spray shield to permit access to the entire length of the screening cylinder for cleaning and other maintenance functions. The inventor has appreciated that providing the rotating screening cylinder in a position rotatably mounted within a containment housing which extends about the entire periphery of the cylindrical wall advantageously minimizes any undesirable overspray and noise in the classifying operation of the apparatus. The sidewalls of the spray shield are preferably formed from a unitary sheet of steel or several sheets of steel welded together either before or after bending to form integral sidewalls. Preferably, the spray shield extends lengthwise along the entire length of the screening cylinder, and includes end covers or doors to fully encase and contain the screening cylinder.

To further reduce filtrate spray, the influent input end and discharge end of the screening cylinder may be covered by respective end plates or sealable access doors. The end access doors are preferably provided for sealing mated engagement with the casing, the sidewalls or other bulk-head construction to assist in maintaining the filtrate and influent within the containment housing in classifying operations.

Accordingly, in one aspect the present invention resides in a rotary screening apparatus for increasing the solid content of influent, said apparatus comprising,

a hollow screening cylinder having a central longitudinal axis and comprising a plurality of coaxially aligned cylindrical sections, each of said cylindrical sections having an inlet end and an outlet end and a generally cylindrical wall, the cylindrical wall comprising a plurality of screen panels and with the outlet end of a first one of said cylindrical sections being secured in co-axial alignment with an inlet end of a next adjacent cylindrical section,

the longitudinal axis oriented at approximately 0 to 45° from horizontal, the screening cylinder being mounted for journalled in rotation about the axis and including an inlet opening, and a discharge opening,

conveying means for delivering said influent into the interior of the cylinder via said inlet end,

roller means for rotatably supporting said cylinder,

rotation means for rotating said cylinder about the axis,

casing for housing said cylinder, the casing including lower shield means for containing filtrate from said influent which passes downwardly through said screening cylinder.

In another aspect, the present invention resides in a kaolin classifying apparatus for separating solid kaolin particles from a kaolin influent slurry, said apparatus comprising,

a hollow screening cylinder having a central axis oriented at approximately 0 to 10° from horizontal, the cylinder comprising a plurality of coaxially aligned modular cylinder sections, each of said cylinder sections comprising a cylinder frame having a plurality of interchangeable screen panels secured thereto, the screen panels forming a screening surface of said cylinder, the screening cylinder being journalled for rotation about said axis and including an inlet end, and a discharge end,

a plurality of rollers for engaging part of the frame of at least one of said cylindrical sections to rotatably support a portion of said screening cylinder,

conveying apparatus for delivering said influent slurry into the interior of said screening cylinder via the inlet end.

In a further aspect, the present invention resides in a rotary screening apparatus for increasing the solid content of influent, said apparatus comprising,

a hollow cylinder having a central axis oriented at an angle inclined at an angle of approximately 0 to 40° from horizontal and being rotatable about said axis, the cylinder comprising a plurality of modular cylindrical sections, each cylindrical section having an inlet end and an outlet end with the outlet end of each cylinder section matedly coupled to the inlet end of the next adjacent section, the cylinder sections further including a cylinder frame, a plurality of screen panels detachably coupled to an exterior side of said frame and forming a screening surface,

a plurality of rollers for engaging at least one cylinder frame to rotatably support at least part of said cylinder,

a casing for housing the cylinder, the casing including a cover for containing filtrate from said influent which passes through said screening surface,

each of said modular cylinder sections has an axial length selected at between about 0.5 and 2 meters.

### BRIEF DESCRIPTION OF THE DRAWINGS

Further aspects and advantages of the present invention will now appear from the following detailed description taken together with the accompanying drawings in which:

FIG. 1 illustrates a perspective view of a top and front side of a rotary screening apparatus in accordance with a preferred embodiment of the invention;

FIG. 2 shows a partially cut away view of the screening apparatus of FIG. 1;

FIG. 3 illustrates a perspective top and rear side view of the apparatus shown in FIG. 1;

FIG. 4 illustrates a schematic side view of the apparatus of FIG. 1;

FIG. 5 illustrates a perspective top and front view of the apparatus shown in FIG. 1 with the filter screen access panel doors shown in an open position;

FIG. 6 illustrates schematically a perspective view of a modular cylinder section used in the screening apparatus of FIG. 1;

FIG. 7 illustrates an enlarged perspective view of a screen panel used in the cylinder section of FIG. 6;

FIG. 8 illustrates schematically an enlarged schematic end view of a cylinder section and screen panel used in the screening apparatus of FIG. 1;

FIGS. 9 and 10 illustrate enlarged partial exploded views of the screening panel of FIG. 7 illustrating its attachment to the cylinder frame;

FIG. 11 shows an exploded perspective view of a containment housing used in the apparatus of FIG. 1 with the screening cylinder removed; and

FIG. 12 shows a partial sectional view of a supporting wheel for use in the screening apparatus in accordance with the preferred embodiment.

### DETAILED DESCRIPTION OF THE PREFERRED EMBODIMENTS

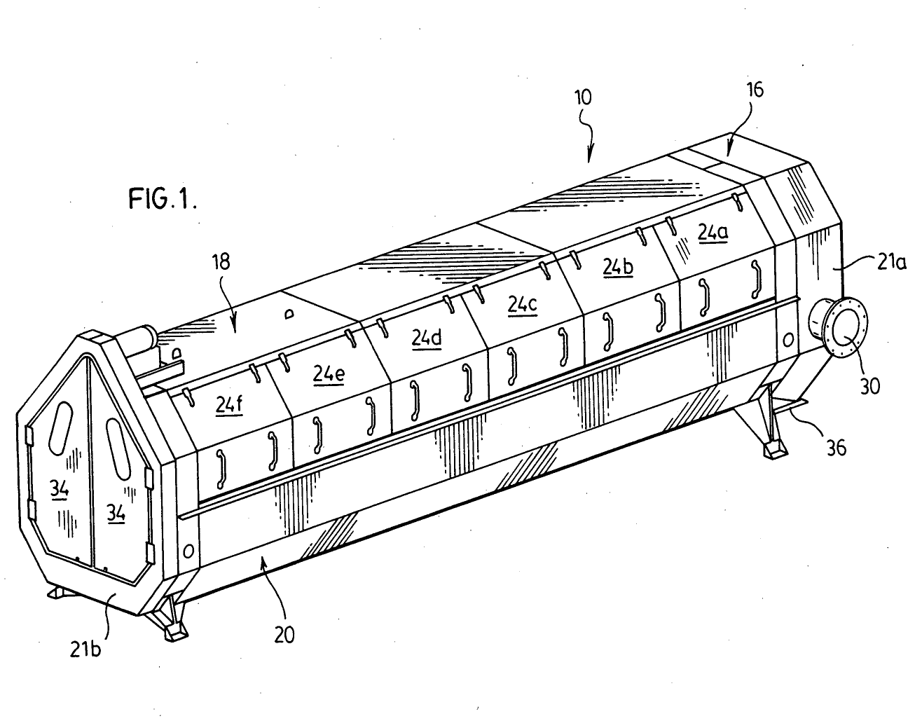

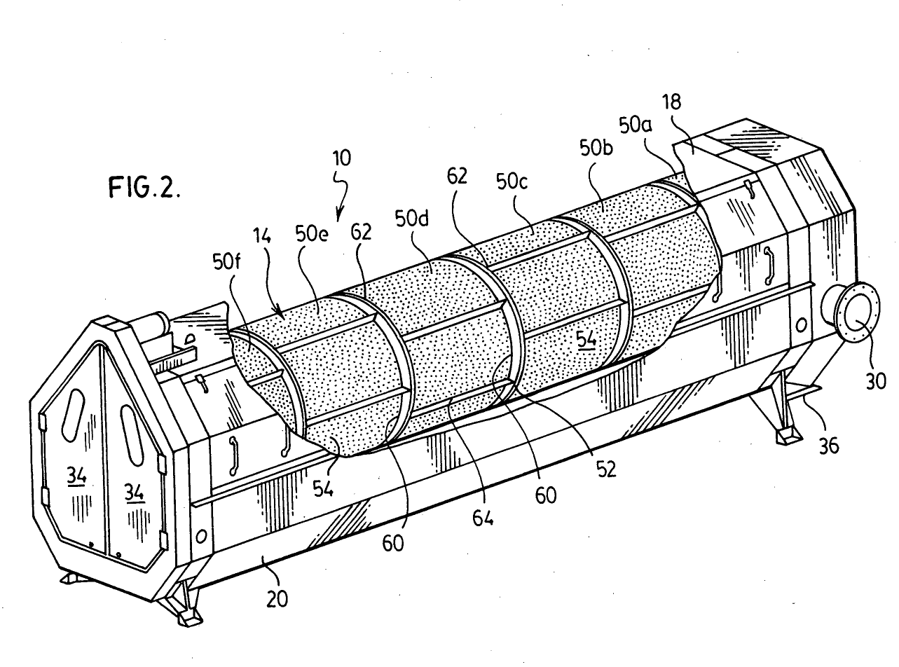

Reference is made first to FIGS. 1 and 2 which show a pictorial view of a rotary screening apparatus 10 for use in the classification of kaolin solids from an influent slurry in accordance with a preferred embodiment of the present invention. The screening apparatus includes an elongated hollow screening cylinder 14 (shown in the partially cut away view of FIG. 2) which is used to separate kaolin solids and filtrate from the slurry, and a containment housing 16.

The screening cylinder 14 has an overall diameter of between about 0.7 to 1.5 meters, and a longitudinal length of between about 5 and 8 meters, and more preferably about 6 meters.

As shown best in FIGS. 1 and 3 to 5 the containment housing 16 is formed as a generally two-piece casing which includes a cover 18, a lower spray shield 20 and a pair of end bulk heads 21a, 21b which are used to provide closed ends of the housing 16. The cover 18 and spray shield 20 have a size selected relative to the screening cylinder 14 so that the cylinder 14 is completely encircled by the containment housing 16 when the top cover 18 is positioned over the spray shield 20 and connected thereto.

The lower spray shield 20 is preferably formed having sidewalls formed from sheets of bent 3/16″ to ¼″ thick stainless or structural steel which are welded together to form each half of a generally U-shape. The welded integral construction of the spray shield 20 and thickness of steel used advantageously ensures that the influent and any filtrate passing through the screening cylinder 14 are retained within the screening apparatus 10. In addition the robustness of the spray shield 20 further permits it to function as the frame upon which the screening cylinder 14 is supported.

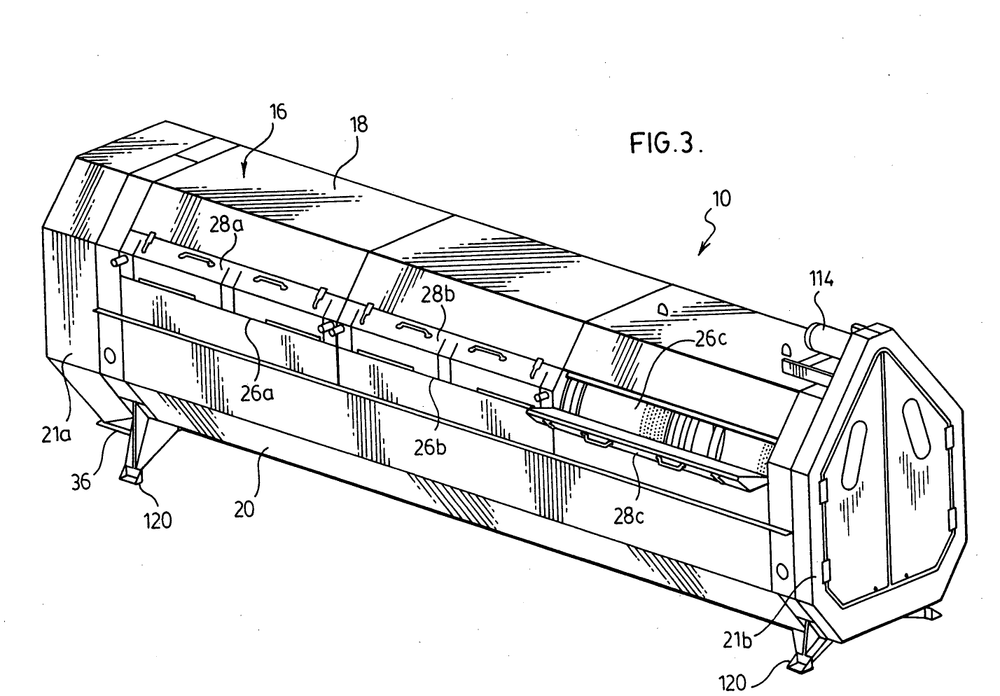

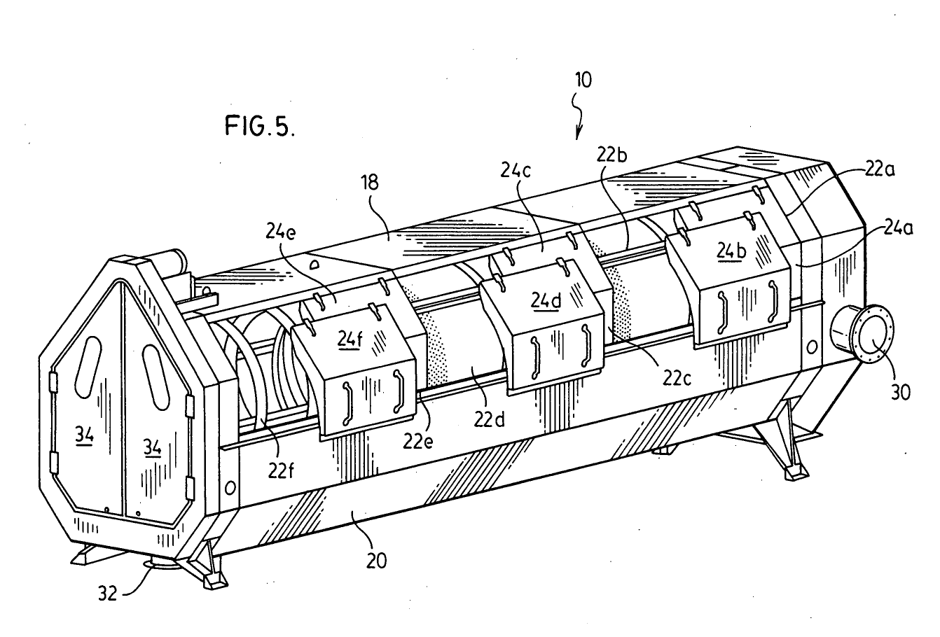

In the embodiment shown, the cover 18 is preferably made of the same material and in a similar construction as the spray shield 20. As shown best in FIGS. 1 and 5 a series of elongate front access openings 22a-22f are formed though the front of the cover 18. The openings have a preferred length of between about 0.5 and 2 meters and a lateral width of between about 0.7 and 1.5 meters. Screen panel access doors 24a, 24b, 24c, 24d, 24e, 24f are provided over each of the openings 22a-22d, respectively, which may be closed to provide a substantially fluid-tight seal thereof. The access doors 24a-24f may be selectively opened to provide access into the interior of the housing 16 as for example is shown in FIG. 5. The access openings 22a-22f are preferably located in a generally upper region of the containment housing 16, allowing the access doors 24a-24f to be opened and service performed on the screening cylinder 14 without necessitating that the entire apparatus 10 be drained of influent. As shown best in FIG. 3, the cover 18 optionally further may include rear access openings 26a, 26b, 26c. The rear access openings 26a, 26b, 26c are preferably also formed in an upper region of the cover 18 and are sealable in a substantially fluid tight manner by closing rear doors 28a, 28b, 28c, respectively. The rear access openings 26a-c may be made smaller than the front openings 22 and provide access to the interior of the housing 16 to enable service of a backwash spray unit (not shown) used to provide a cleaning water spray along the outer surface of the screening cylinder 14.

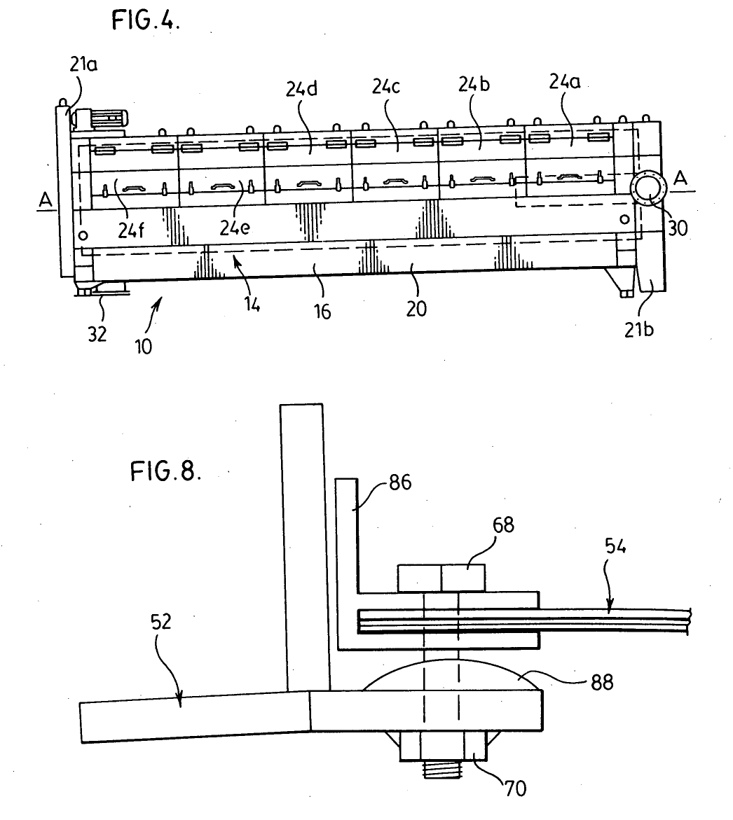

An influent input pipe 30 (FIG. 4) extends through an opening in the end bulkhead 21a and into the interior of the screening cylinder 14. In use of the screening apparatus 10, unclassified kaolin slurry is initially pumped into the apparatus 10 via the input pipe 30 into the screening cylinder 14. A discharge outlet 32 is formed through the spray shield 20 adjacent the bulkhead 21a allowing for removal of filtrate from the interior of the apparatus 10. The containment housing 16 is used to rotatably support the screening cylinder 14 with its longitudinal axis A-A (FIG. 4) in a position generally inclined. In the processing of kaolin and other clay slurries, preferably the screening cylinder 14 is inclined from a raised infeed end spaced closest the input pipe 30 to a lower discharge end adjacent the filtrate discharge outlet 32 at an angle of between about 5 and 15 degrees and more preferably about 10 degrees from horizontal.

The end bulk head 21b is shown best in FIG. 1 as including end doors 34 which may be opened to permit access into the interior of the screening cylinder 14 for either removal of any retained kaolin solids therefrom or to permit maintenance or the like. More preferably, one or more helical flights (not shown) are provided along interior portions of the screening cylinder 14. The flights are configured to assist in the axial movement of any retained solid kaolin particles from the input opening towards the doors 34, and outwardly therethrough following the completion of classifying operations. In an alternate possible construction, the flights may be provided to redirect retained solids away from the fluid discharge outlet 32 in the reverse direction of influent fluid flow, past the input pipe 30 and into a collection hopper 36.

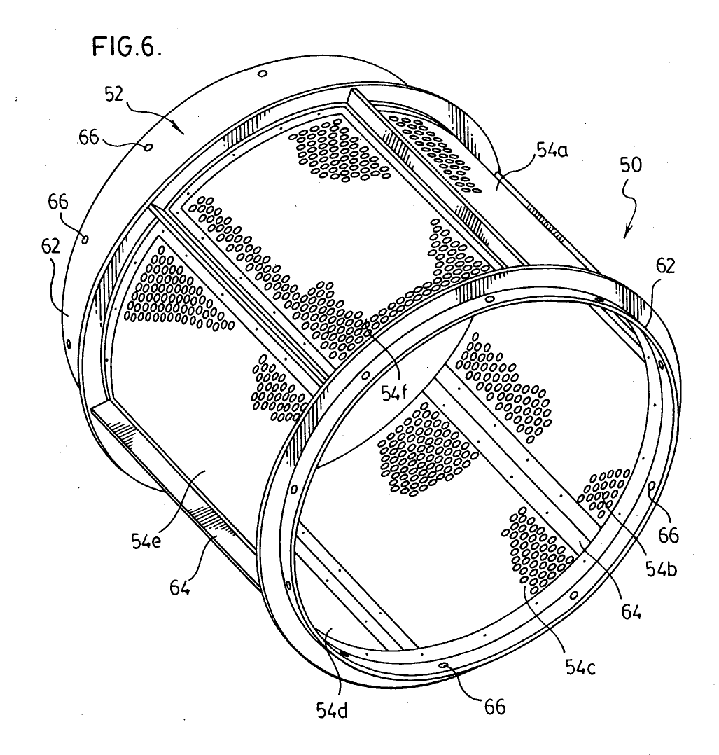

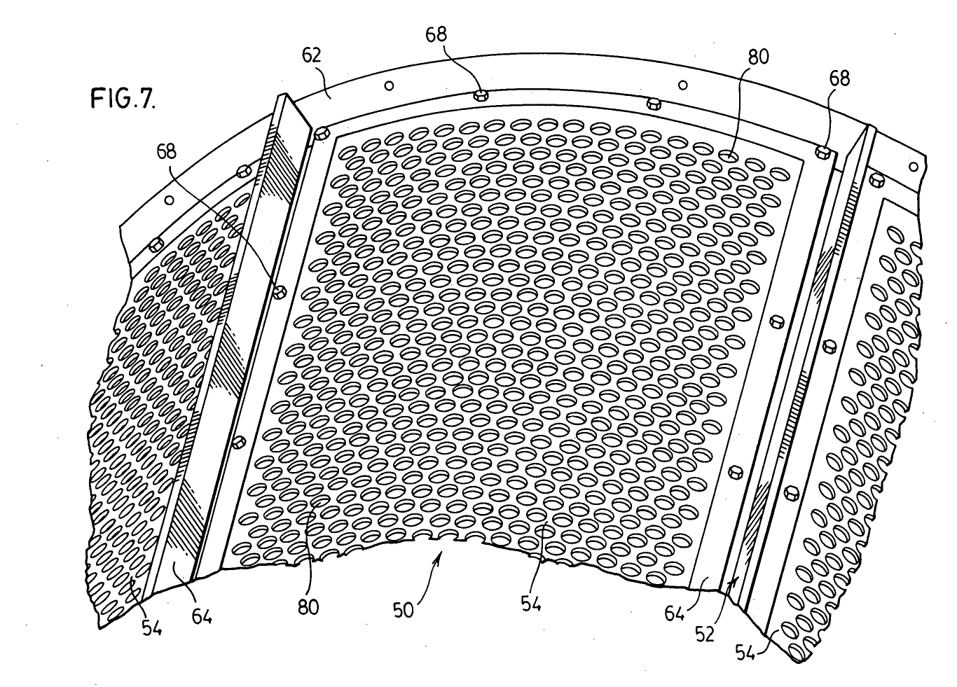

FIG. 2 shown best the screening cylinder 14 as being comprised of six modular cylinder sections 50a, 50b, 50c, 50d, 50e, 50f which are coupled together in coaxial alignment. The cylinder sections 50 preferably each have the identical construction shown in FIGS. 6 and 7, and have a longitudinal length selected at between about 0.7 and 2 meters, and more preferably a length generally corresponding to the longitudinal length of the access openings 22a, 22b, 22c, 22d, 22e, 22f. Each cylinder section 50 includes a steel or other metal cylinder frame 52 which has detachably mounted thereto a number of replaceable screen panels 54a, 54b, 54c, 54d, 54e, 54f.

The cylinder frame 52 is provided with a circular input end hoop 60, and a circular output end hoop 62. A sufficient number of axially extending T-shaped frame members 64 are permanently coupled to each of the hoops 60, 62 by weldments or the like, to provide the necessary structural integrity to the cylinder sections 50. The input end hoop 60 is provided with a radial diameter marginally greater than that of the output end hoop 62. This construction advantageously permits sliding insertion of the edge portion of the output end hoop 62 of a first cylinder section 50a (FIG. 2) into overlapping juxtaposition with the input end hoop 60 of a next adjacent cylinder section 50b. Once so positioned, the cylinder sections 50a, 50b are joined to each other by welding, or more preferably by the insertion of bolts or other mechanical fasters (not shown) through aligned bore holes 66 formed though the juxtaposed portions of the hoops 60, 62. The modular construction of the cylinder sections 50 advantageously allows the simplified construction of screening cylinders 14 of varying lengths, merely by selecting the desired number of cylinder sections 50 to be used.

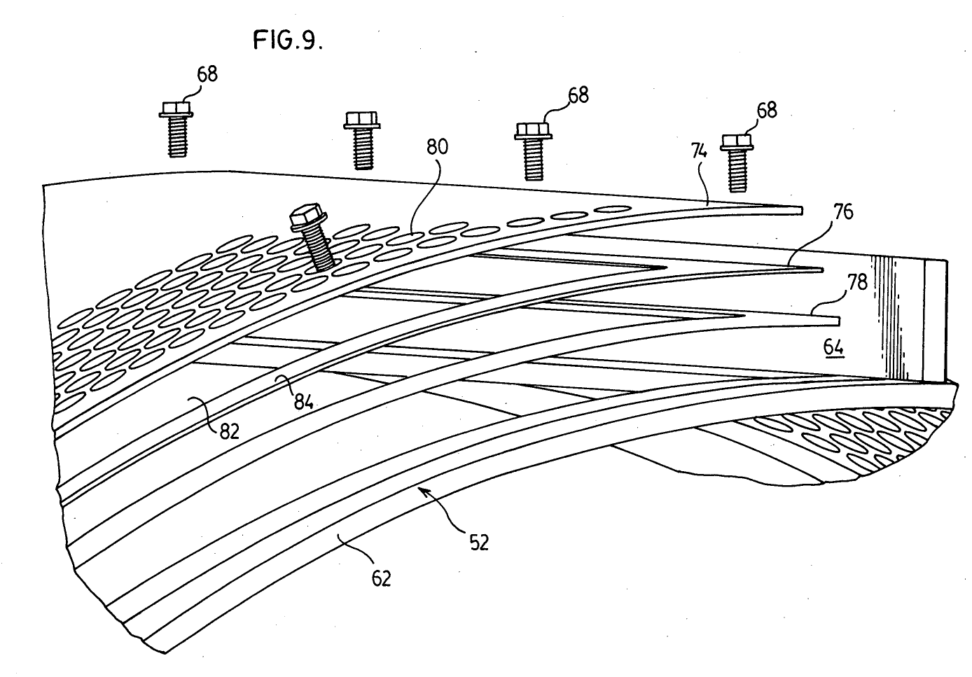

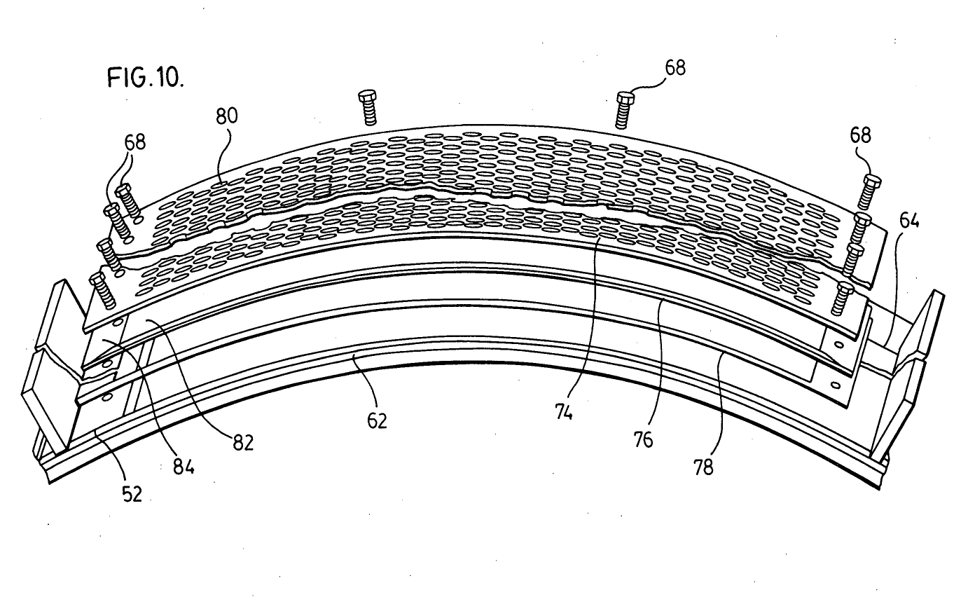

FIGS. 7 to 10 show best the attachment of the screen panels 54 to the cylinder frame 52. Although not essential, most preferably the screen panels 54 are each provided with an identical size, shape and three layer construction so as to permit their mounting interchangeably both at different positions along the exterior of a selected cylinder fame 52, as well as between different cylinder sections 50a, 50b, 50c, 50d, 50e, 50f. The screen panels 54 are shown best in FIGS. 9 and 10 as being secured to the radially outermost exterior surface of the cylinder frame 52 by way of removable screws or bolts 68. The bolts 68 are inserted through apertures formed through the panels 54 and into threaded engagement with nuts 70 (FIG. 8) welded to interior sides of the frame 52. The bolts 68 are provided to allow removal and replacement of clogged or damaged screen panels 54 through the front access openings 22, without necessitating either the removal of the screening cylinder 14 from the containment housing 16, or removal of the panels 54 from within the interior of the screening cylinder 14.

The screen panels 54 each include a rigid backing plate 74, a screen membrane 76 and a seal member 78. The backing plate 74 functions to support the screen membrane 76 in operation of the apparatus 10. The backing plate 74 is formed of a 0.2 to 1.5 cm thick metal plate such as stainless steel or aluminium. As shown best in FIGS. 7 and 9 with the exception of edge portions which are positioned for overlapping placement with the cylinder frame 52, the backing plate 74 is predominantly formed having an array of through openings 80 formed therethrough. The through openings 80 are preferably generally circular or hexagonal in shape and have an average cross sectional diameter of between about 1 and 4 cm, and more preferably about 2.5 cm so as to permit the substantially unhindered movement of filtrate therethrough.

Where the apparatus 10 is configured for use in classifying kaolin slurries, the screen membrane 76 preferably comprises a 400 mesh stainless steel screen 82. For added durability the edge portions of the membrane 76 which are adapted for juxtaposed placement with the cylinder frame 52 are provided with fabric reinforcing overlay 84, to provide increased resistance to tearing.

The seal member 78 is preferably formed as a molded rubber gasket. In installation of the screen panels 54, the seal member 78 is provided in sealing contact with the membrane 76 and frame 52 to form a substantially fluid tight seal between the cylindrical frame 52 and the panel 54, and prevent influent from passing therebetween.

FIG. 8 shows an alternate possible construction wherein the edge portions of the screen panel 54 are engaged by rubber seals 86, 88 to provide a still enhanced fluid tight construction.

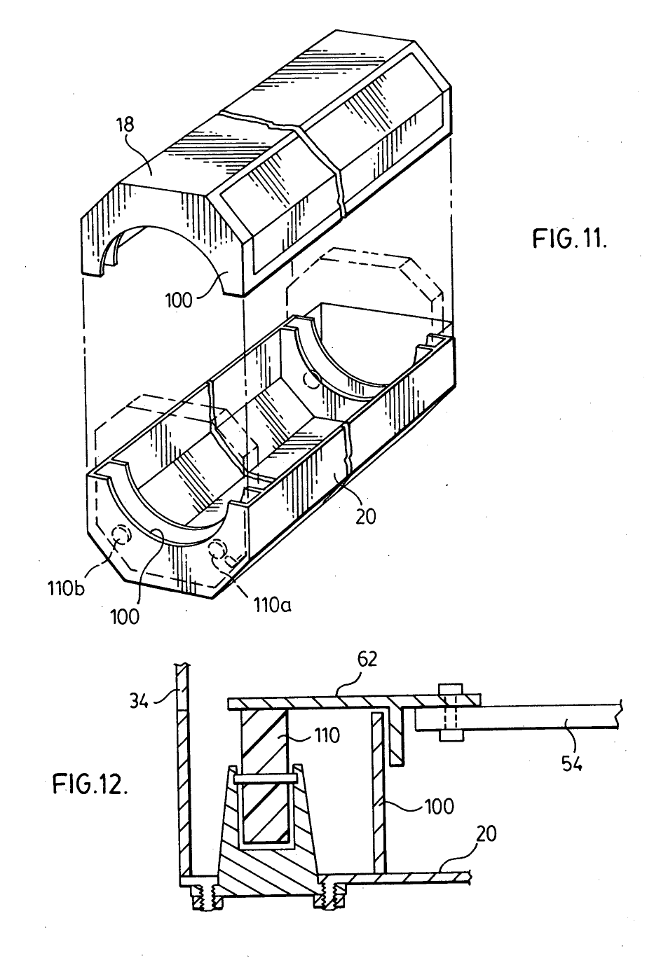

FIG. 11 shows a preferred housing construction wherein solid steel inlet end deflector plates 100 are welded to the cover 18 and spray shield 20 adjacent the discharge outlet 32. The deflector plates 100 extend towards a peripheral edge of the screening cylinder 14 part way towards the cylinder axis A-A. The cover plates 100 act to assist in preventing influent movement outwardly from the end of the screening cylinder 14 and housing 16.

Influent is supplied into the cylinder 14 by an input influent pipe 30, which as shown in FIG. 4, extends into the interior of the cylinder 14. A dispersion tray (not shown) may optionally be coupled to the end of the influent pipe 30 within the cylinder 14 to assist in evenly dispersing influent over the surface of the screen panels 54.

FIG. 11 and 12 shows support wheels 110a, 110b as being secured to the housing 16. It is to be appreciated that four metal, plastic (ie. Nylon™) or rubber wheels 110 are each rotatably mounted on a suitable support 57 which are welded or bolted at spaced locations along the spray shield 20. The wheels 110 are spaced so that axially opposing pairs of wheels are engagable with endmost hoops 60, 62 of the endmost cylinder sections 50a, 50f, when the screening cylinder 14 is positioned within the containment housing 16. The cylinder 14 is positioned in the spray shield 20 between the end bulk heads 21a, 21b. The cylinder 14 is oriented with its central axis A-A inclining downwardly from the input pipe opening 30 to the discharge outlet 32 at the desired orientation by adjusting the height of the supporting legs 112 (FIG. 3) positioned on the underside of the housing 16 to provide the desired inclination. The screening cylinder 14 is journalled for rotation about its axis A-A, and resting on the four wheels 110 by means of a motor driven chain drive 114. The chain drive 114 includes a drive motor which carries a conventional drive sprocket, a drive chain and a driven sprocket (not shown) which is connected to the screening cylinder 14. The drive sprocket is configured to engage the drive chain such that the drive motor rotates the cylinder 14 about its axis A-A.

While FIG. 1 shows a rotary screening apparatus 10 having a trough-shaped spray shield 20 with two bulk heads 21a, 21b and a cover 18, other containment housing 16 configurations are also possible. It is to be appreciated that providing a containment housing 16 which encircles the entire periphery of the cylinder 14 is highly preferable in that it contains and directs filtrate for collection via the discharge outlet 32. The containment housing 16 further acts to advantageously reduce noise during the use of the screening apparatus 10. Although in the preferred embodiment the top cover 18, like the spray shield 20, is formed from steel and is removably secured thereto by bolts (not shown) or the like, the invention is not so limited. It is not required that the cover 18 have the same structural integrity as the spray shield 20 and lighter gauges of steel may be used In operation, an influent slurry of kaolin is directed into the interior of the cylinder 14 and on to the screen membranes 76 of the screen panels 54. During operation, the slurry may be either continuously pumped into the cylinder 14 and onto the screen panels 54 or input as part of a batch process. The influent slurry is conveyed along the input pipe 30 by a pump or screw feed (not shown). As the slurry is pumped into the cylinder 14, on first contacting the screen membranes 76, filtrate from the slurry passes downwardly through the panels 54 via the screen 82 and through openings 80 of the backing plates 74 under gravity. Any retained kaolin particles to be collected and which are too large to pass through the screen 82 of the screen membranes 76 is retained within the cylinder 14. As the filtrate moves downwardly through the screen panels 54, it is collected in the spray shield 20 and directed outwardly therefrom via the discharge outlet 32. The retained solids are in turn moved via flights to either the hopper 36, or alternately, in a less preferred construction may be removed via end doors 34.

It is to be appreciated that the foregoing construction also advantageously permits replacement of damaged or clogged screen panels 54. Screen panels 54 may be replaced without requiring removal of the screening cylinder 14 from the housing 16, or even the complete draining of the housing 16 as for example would be necessary when replacing panels 54 from within the interior of the cylinder 14. To replace a screen panel 54, the apparatus 10 is simply stopped with the damaged panel 54 rotated into position aligned with the applicable access opening 22a-f. The adjacent access door 24a-f is then opened and the damaged panel 54 is unbolted from the frame 52 and removed and a new panel 54 is installed by reinserting the bolts in its place. The access door 24 is then resealed and the apparatus 10 is then restarted to recommence classifying operations.

The preferred embodiment of the invention discloses the present apparatus for use in increasing the solid content of kaolin from an influent slurry. The screening apparatus is, however, equally suitable for other uses including, for example, increase in the solid content of the clay containing slurries, as well as wood pulp, sewage, sludge and/or food processing.

Although the detailed description describes preferred embodiments of the invention, the invention is not so limited and many modifications and variations will now occur to persons skilled in this art. For a definition of the invention, reference may be had to the appended claims.

I claim:

1. A rotary screening apparatus for increasing the solid content of influent, said apparatus comprising,
a hollow screening cylinder having a central longitudinal axis and comprising a plurality of coaxially aligned cylindrical sections, each of said cylindrical sections having an inlet end and an outlet end and a generally cylindrical wall, the cylindrical wall comprising a plurality of screen panels and with the outlet end of a first one of said cylindrical sections being secured in co-axial alignment with an inlet end of a next adjacent cylindrical section,
the longitudinal axis oriented at approximately 0 to 45° from horizontal, the screening cylinder being mounted for journalled in rotation about the axis and including an inlet opening, and a discharge opening,
conveying means for delivering said influent into the interior of the cylinder via said inlet end,
roller means for rotatably supporting said cylinder,
rotation means for rotating said cylinder about the axis,
casing for housing said cylinder, the casing including lower shield means for containing filtrate from said influent which passes downwardly through said screening cylinder.

2. An apparatus of claim 1 wherein each of said modular cylinder sections has an axial length selected at between about 0.5 and 2 meters and further comprises,
a cylindrical frame having a first hoop end and a second hoop end, and a plurality of brace members connecting said first and second hoop ends and extending generally in the axial direction.

3. An apparatus as claimed in claim 2 wherein each of said screen panels comprises an interchangeable modular screen panel.

4. An apparatus as claimed in claim 2 wherein each of said screen panels includes a flexible mesh layer of 400 mesh or greater, and a substantially rigid backing plate for supporting said mesh layer, said backing plate further including an array of apertures formed therethrough sized to permit substantially unhindered movement of filtrate therethrough.

5. An apparatus as claimed in claim 4 wherein said casing includes upper sidewall means having an uppermost top portion and cover edge sidewall portions extending downwardly from opposite sides of the top portion so that said casing substantially encircles said screening cylinder, the top portion and the cover sidewall portions being integrally formed from a unitary sheet of metal.

6. An apparatus as claimed in claim 5 further including an access door formed through said cover edge sidewall portions, the access door being sized to enable removal and replacement of a selected one of said screen panels therethrough without requiring removal of the screening cylinder from said casing.

7. An apparatus as claimed in claim 4 further including an inlet end opening extending into the interior of said cylinder spaced towards said axis,
said conveying means delivering said influent into said screening cylinder via the inlet opening.

8. A screening apparatus as claimed in claim 5 wherein said screen panels further comprise a seal member disposed between said mesh layer and said frame.

9. An apparatus as claimed in claim 8 wherein said apparatus comprises a kaolin classifying apparatus, said screening cylinder having a longitudinal length selected greater than about 3 meters with said axis inclined downwardly towards said discharge opening at between 0 and 5 degrees from horizontal.

10. A kaolin classifying apparatus for separating solid kaolin particles from a kaolin influent slurry, said apparatus comprising,
a hollow screening cylinder having a central axis oriented at approximately 0 to 10° from horizontal, the cylinder comprising a plurality of coaxially aligned modular cylinder sections, each of said cylinder sections comprising a cylinder frame having a plurality of interchangeable screen panels secured thereto, the screen panels forming a screening surface of said cylinder, the screening cylinder being journalled for rotation about said axis and including an inlet end, and a discharge end,
a plurality of rollers for engaging part of the frame of at least one of said cylindrical sections to rotatably support a portion of said screening cylinder,
conveying apparatus for delivering said influent slurry into the interior of said screening cylinder via the inlet end.

11. A kaolin classifying apparatus as claimed in claim 10 further comprising a casing for housing the screening cylinder, and wherein the screening cylinder has an axial length selected at between about 3 and 7 meters.

12. A kaolin classifying apparatus as claimed in claim 11 wherein each of said modular cylinder sections has an axial length selected at between about 0.5 and 2 meters and further comprises,
a cylindrical frame having a first hoop end and a second hoop end, and a plurality of brace members connecting said first and second hoop ends and extending generally in the axial direction.

13. A kaolin classifying apparatus as claimed in claim 11 wherein each of said screen panels comprises an interchangeable modular screen panel.

14. A kaolin classifying apparatus as claimed in claim 11 wherein each of said screen panels includes a flexible mesh layer of at least 400 mesh, and a substantially rigid backing plate for supporting said mesh layer, said backing plate further including an array of apertures sized to permit substantially unhindered movement of filtrate therethrough.

15. A kaolin classifying apparatus as claimed in claim 14 wherein said apertures have a diameter of between about 1 and 4 cm.

16. A rotary screening apparatus for increasing the solid content of influent, said apparatus comprising,
a hollow cylinder having a central axis oriented at an angle inclined at an angle of approximately 0 to 40° from horizontal and being rotatable about said axis, the cylinder comprising a plurality of modular cylindrical sections, each cylindrical section having an inlet end and an outlet end with the outlet end of each cylinder section matedly coupled to the inlet end of the next adjacent section, the cylinder sections further including a cylinder frame, a plurality of screen panels detachably coupled to an exterior side of said frame and forming a screening surface,
a plurality of rollers for engaging at least one cylinder frame to rotatably support at least part of said cylinder,
a casing for housing the cylinder, the casing including a cover for containing filtrate from said influent which passes through said screening surface,
each of said modular cylinder sections has an axial length selected at between about 0.5 and 2 meters.

17. A rotary screening device as claimed in claim 16 wherein said cylinder frame further comprises, a first hoop end and a second hoop end, and a plurality of brace members connecting said first and second hoop ends and extending generally in the axial direction.

18. An apparatus as claimed in claim 17 each of said screen panels includes a flexible mesh layer of 400 mesh or greater, and a substantially rigid backing plate for supporting said mesh layer, said backing plate further including an array of apertures having a diameter selected at between about 1 and 4 cm to permit movement of filtrate therethrough.

19. An apparatus as claimed in claim 18 wherein screen panels further comprise an elastomeric sealing member provided for placement interposed between said mesh layer and said cylinder frame to provide a substantially fluid tight seal therebetween.

20. An apparatus as claimed in claim 19 wherein said screen panels comprise interchangeable panels having a longitudinal length of between about 0.75 and 2 meters, and a lateral width of between about 0.25 and 1 meters, said backer plate being curved in a lateral direction.
